(19) United States
(12) Patent Application Publication
(10) Pub. No.: US 2005/0018978 A1
(43) Pub. Date: Jan. 27, 2005

(54) Opto-electric module and method of assembling

(75) Inventors: Ron Nevo, Fair-Lawn, NJ (US); Dominic Canace, Edison, NJ (US); William John Schnoor, Middletown, PA (US)

Correspondence Address: TYCO ELECTRONICS CORPORATION, 4550 NEW LINDEN HILL ROAD, SUITE 450, WILMINGTON, DE, 19808, US

(73) Assignee: Tyco Electronics Corporation, Middletown, PA (US)

(21) Appl. No.: 10/825,520

(22) Filed: Apr. 15, 2004

Related U.S. Application Data
(63) Continuation-in-part of application No. 10/036,970, filed on Dec. 21, 2001, now abandoned.
(60) Provisional application No. 60/516,675, filed on Nov. 3, 2003.

(51) Int. Cl. G02B 6/36

(52) U.S. Cl. 385/92

(57) ABSTRACT

An opto-electric module comprising: (a) an OSA having an optical axis, and optical end, an electrical end; (b) a planar circuit board having top and bottom surfaces and one or more electrical contacts on at least one of the surfaces of the circuit board; (c) a connector interface for receiving a mating connector; (d) a substrate connected to the connector interface, the OSA and the circuit board, the substrate holding the circuit board parallel to the optical axis of the OSA; and (e) an electrical interface between the electrical end of the OSA and the electrical contacts of the circuit board, the electrical interface comprising a flexible conductor extending orthogonally from the optical axis of the OSA and bending around to overlay the electrical contacts on the circuit board.

### REFERENCE TO RELATED APPLICATIONS

This application claims priority to U.S. patent application Ser. No. 10/036,970 filed on Dec. 21, 2001, and to U.S. Provisional Application No. 60/516,675 filed on Nov. 3, 2003, both of which are hereby incorporated by reference.

### FIELD OF INVENTION

The present invention relates generally to an opto-electrical module and a method of assembling it, and, more specifically, to an opto-electric module which is configured to be assembled to reduce stress on the electrical interconnections among the various components in the module.

### BACKGROUND

An opto-electric transceiver module converts signals between the electrical and optical domains to transfer data between electrical circuitry and optical fiber. To perform this function, an opto-electric transceiver typically comprises a number of small, discrete components that are precisely aligned and electrically interconnected within the module. These components include, for example, a number of optical sub-assemblies (OSAs) for receiving and transmitting optical signals and a circuit board for receiving electrical signals from the receiving OSA (ROSA) and for driving the transmitting OSA (TOSA) to transmit optical signals. In addition to these opto-electrical components, a transceiver typically comprises a connector interface for receiving an optical connector which contains a number of optical fibers. The connector interface serves to position the optical fibers of the connector to optically couple with the OSAs and to secure the optical connector to the transceiver.

To function properly, the connector interface, OSAs and circuit board must be aligned and secured within the module to properly couple signals between the fiber and the circuit board. Additionally, various electrical interconnections must be effected between the OSAs and the circuit board. These requirements have led to an assembly process in which the electrical interconnections between the OSA and the circuit board are made first to obtain an electrical subassembly, and then this electrical subassembly is placed within the module housing at which point the OSAs are aligned with the connector interface. (See, for example, U.S. Pat. No. 5,596,665 issued to Kurashima, et al.).

Although this prior art assembly approach meets the requirements of aligning and electrically connecting the various components, applicants have discovered that this approach introduces mechanical stresses between the OSAs and the circuit board during their installation into the module housing. These stresses present a number of problems. First, given the delicate nature of the components, any relative movement between them will necessarily introduce stresses in their electrical interconnections which may compromise electrical performance. For example, stress may cause the electrical interconnection to bend or crack at its joints, thereby altering the impedance of the electrical circuit and thus cause performance variations among different modules. Second, the OSAs are generally manufactured to be hermetic, requiring that the electrical leads which extend from the OSA be sealed with glass and metal. These glass/metal seals are quite rigid and intolerant of stress. Therefore, any stress on these leads may cause the integrity of the seal to be compromised and the hermetically of the OSA to be destroyed. Therefore, stresses on the electrical interconnection between the OSAs and the circuit board may compromise the module's electrical performance and structural integrity.

Therefore, there is a need to provide an opto-electric module assembly approach which reduces the mechanical stresses on the electrical interconnects between the OSAs and the circuit board. The present invention fulfills this need among others.

### SUMMARY OF INVENTION

The present invention provides for a method of assembling an opto-electric module which avoids mechanically stressing the electrical interconnections between the various components by placing and aligning the various components in the opto-electrical module prior to effecting their electrical connection. Since the relative position of the components is fixed before they are electrical interconnected, there is little or no stress on the electrical interconnection. By reducing these stresses, the electrical and structural integrity of the module can be maintained.

Accordingly, one aspect of the present invention is a method for assembling an opto-electric module by effecting the electrical interconnections among the components after the components are placed and aligned in the module housing. In a preferred embodiment, the method comprises: (a) providing an assembly comprising a connector interface and a substrate having a cavity for receiving an OSA, the cavity being aligned with the connector interface such that, when the OSA is disposed in the cavity, the OSA is positioned to optically couple with a mating connector of an optical component connected to the connector interface; (b) affixing the circuit board to the substrate in a particular position relative to the cavity such that, when the OSA is disposed in the cavity, the electrical interface is positioned to electrically couple with contacts on the circuit board; (c) placing the OSA in the cavity; and (d) electrically connecting the electrical interface to the contacts after the OSA is disposed in the cavity and the circuit board is fixed to the substrate.

The present invention also provides for a module in which the electrical interconnection is tolerant of relative movement between the OSA and the circuit board. To this end, a flexible circuit with a bend is used between the OSA and circuit board. The bend in the flexible circuit provides “slack” to allow the OSA to move relative to the circuit board. Therefore, the present invention not only provides a method of assembly which reduces stress in the electrical interconnection between components, but also provides for a electrical interconnection which, in itself, avoids mechanical stresses.

Accordingly, another aspect of the invention is a module in which the interconnection between components has a flexible loop to provide for movement between the components. In a preferred embodiment, the opto-electric module comprises: (a) an OSA having an optical axis, and optical end, an electrical end; (b) a planar circuit board having a top and bottom surfaces and one or more electrical contacts on at least one of the surfaces of the circuit board; (c) an connector interface for receiving a mating connector; (d) a substrate connected to the connector interface, the OSA and the circuit board, the substrate holding the circuit board parallel to the optical axis of the OSA; and (e) an electrical interface between the electrical end of the OSA and the electrical contacts of the circuit board, the electrical interface comprising a flexible conductor extending orthogonally from the optical axis of the OSA and bending around to overlay the electrical contacts on the circuit board.

### BRIEF DESCRIPTION OF DRAWINGS

FIG. 1 is a perspective view of a fully assembled opto-electric module in accordance with the present invention.

FIG. 2 is an exploded view of an opto-electric module in accordance with the present invention.

FIG. 3 is a perspective view of substrate, connector interface, and circuit board in accordance with the present invention.

FIG. 4 is a diagram showing the assembly of the substrate, connector interface, and circuit board in accordance with the present invention.

FIG. 5 is a diagram showing the assembly of the OSA, electric coupling of the OSA with the circuit board, and the assembly of the cover in accordance with the present invention.

FIG. 6 is a perspective view of substrate, connector interface, circuit board, and OSA in accordance with the present invention.

FIG. 7 is a perspective view of an OSA in accordance with the present invention.

FIG. 8 is a perspective view of a fully-assembled, alternative opto-electronic transceiver module in accordance with the present invention.

FIG. 9 is an exploded view of the module shown in FIG. 8.

FIG. 10 is a perspective view of the top housing portion of the module shown in FIG. 8.

FIG. 11 is a perspective view of the bottom of the bottom housing portion of the module shown in FIG. 8.

FIG. 12 is a perspective view of the inside of the bottom housing portion of the module shown in FIG. 8.

FIG. 13 is a left side view of the printed circuit board and receive optical subassembly of the module shown in FIG. 8.

FIG. 14 is a right side view of the printed circuit board and transmit optical subassembly of the module shown in FIG. 8.

FIG. 15 is a bottom perspective view of an electromagnetic interference gasket that may be mounted on the nose of the opto-electronic transceiver module in accordance with the present invention.

FIG. 16 is a front elevation view of the fully assembled module shown in FIG. 8.

FIG. 17 is a plan view of the module of FIG. 8 with the optional electromagnetic interference gasket mounted on the nose thereof.

### DETAILED DESCRIPTION OF PREFERRED EMBODIMENT

The invention herein described is a method of assembling the components of an opto-electric module wherein the step of electrically coupling the components is deferred until the components are spatially disposed and the opto-electric module assembled by such method. Deferring the step of electrically coupling the individual components of the module until the components are assembled reduces the potential of mechanical stress occurring at the electrical connections of the module and on the hermetic seal protecting the interior elements of the OSA.

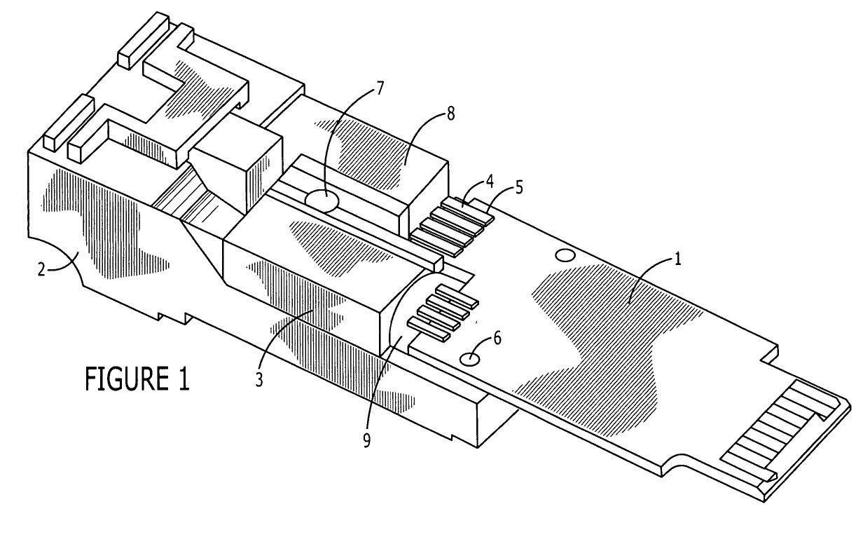

Referring to FIG. 1, an assembled opto-electric module is shown. This opto-electric module is designed to be part of an fiber optic communication system wherein the module receives an optical signal from an optical component, converts the optical signal to an electronic signal, optionally conditions the electronic signal, and then transmits the electronic signal to an electronic component (not shown). Alternatively, the module may be designed to receive an electrical signal from an electronic component, optionally condition the electronic signal, convert the electronic signal to an optical signal, and the transmit the optical signal to an optical component. Additionally, the module may be designed to both receive and transmit optical signals and electronic signals.

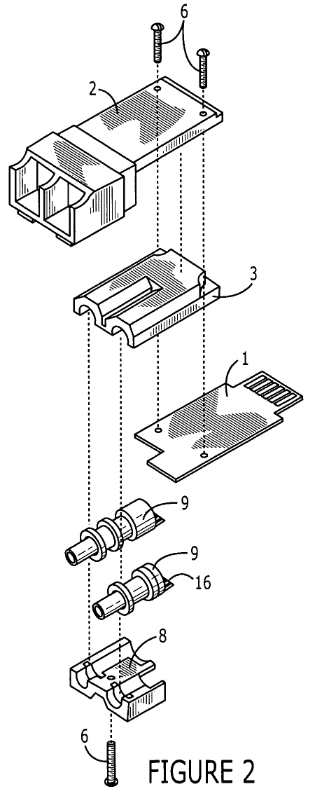

The assembly of this module includes the step of providing an assembly comprising a connector interface 2, a substrate 3, a circuit board 1, and an OSA 9 having an electrical interface 16. Each of these individual components are also shown in FIG. 2. In certain preferred embodiments, the module may also include a cover 8 as well as a second OSA. Additionally, the connector interface 2, the substrate 3, the cover, and the circuit board 1 may be attached via one or more pins 6.

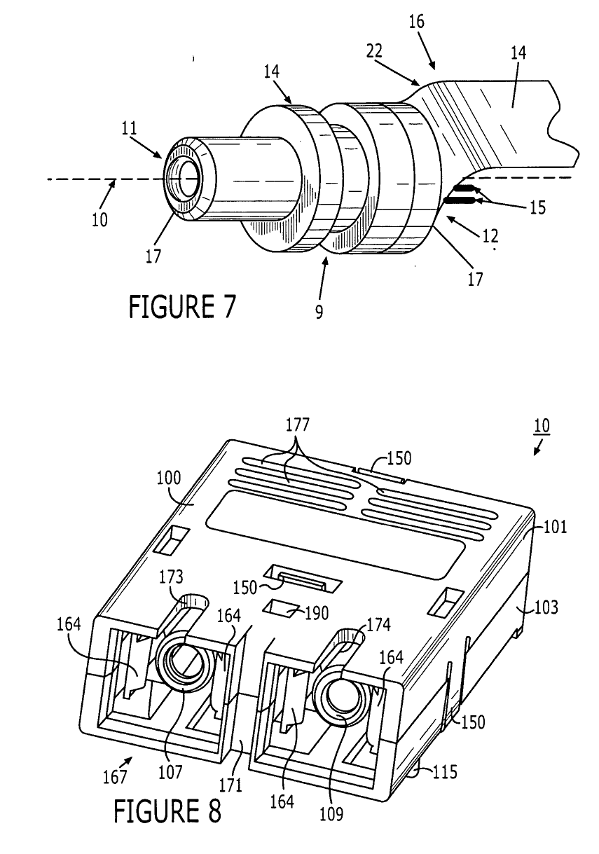

The OSA 9 converts an optical signal to an electronic signal or an electronic signal to an optical signal. As used herein, the term “receiving OSA” refers to an OSA that converts an optical signal into an electronic signal, and the term “transmitting OSA” refers to an OSA that converts an electronic signal into an optical signal. A module that contains both a receiving OSA and a transmitting OSA is called a transceiver. As demonstrated in FIG. 7, an OSA in accordance with this invention has an optical axis 10, an electrical end 12, and an optical end 11. The optical axis is the straight line along which the optical signal is propagated. Optionally, the OSA contains a hermetic seal 17 that isolates its interior elements from the ambient atmosphere. The electrical end of the OSA receives or transmits an electrical signal to or from an electronic component, while the optical end of the OSA receives or transmits an optical signal to or from an optical component.

The connector interface 2 serves to facilitate the optical coupling of the OSA 9 to an optical component (not shown) by aligning the optical end 11 of the OSA with a mating end (not shown) of the optical component.

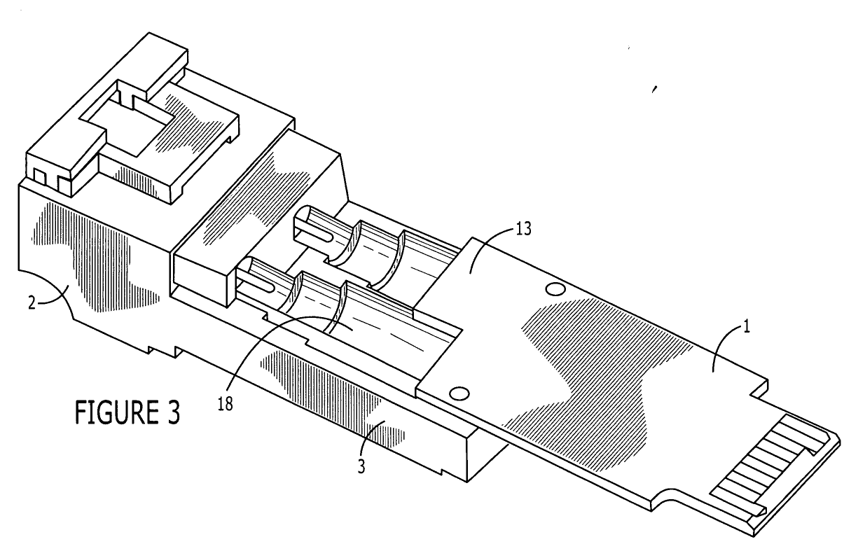

The substrate 3 defining a cavity 18 is used to fix the position of the OSA with respect to the optical connector. The surface of the cavity is dimensioned to match the contour 14 of the OSA so that when the OSA is disposed in the cavity, the OSA's position is defined within the module and the motion of the OSA with respect to the module is restricted. Moreover, the cavity is further oriented with respect to the connector interface 2 so that when the OSA is disposed in the cavity, the OSA is positioned to optically couple with the mating connector of an optical component attached to the connector interface. In a preferred embodiment, the substrate is resilient and urges against the OSA so as to fix the OSA within the cavity. As shown in FIG. 3, in another preferred embodiment of the present invention, the substrate may contain a second cavity for receiving a second OSA.

Referring to FIG. 7, the electrical end 12 of the OSA includes an electrical interface 16. The interface comprises flexible electrical conductors 4 that are attached to leads 15 extending from the electrical end of the OSA. As shown in FIG. 7, the leads extend from the OSA approximately parallel to the optical axis 10. The leads join the electrical conductors at approximately an orthogonal angle. The flexible conductors are bend at approximately a right angle so that one end of the conductors are orthogonal to the leads and the other end of the conductors are parallel to the leads. However, it should be understood that this embodiment is only exemplary and that the invention can be applied to other configurations of the electrical interface as well.

The electrical interface 16 serves as an electrical junction between the OSA 9 and the circuit board 1. According to the present invention, a circuit board 1 is an insulated board on which interconnected circuits and components such as microchips, amplifies, filters, and a digital potentiometer can be mounted or etched (not shown). The circuit board conditions the electronic signals as necessary. As shown in FIG. 3, the circuit broad is generally planar with respect to at least one of its surfaces and comprises one or more electrical contacts 13 on at least one of these planar surfaces.

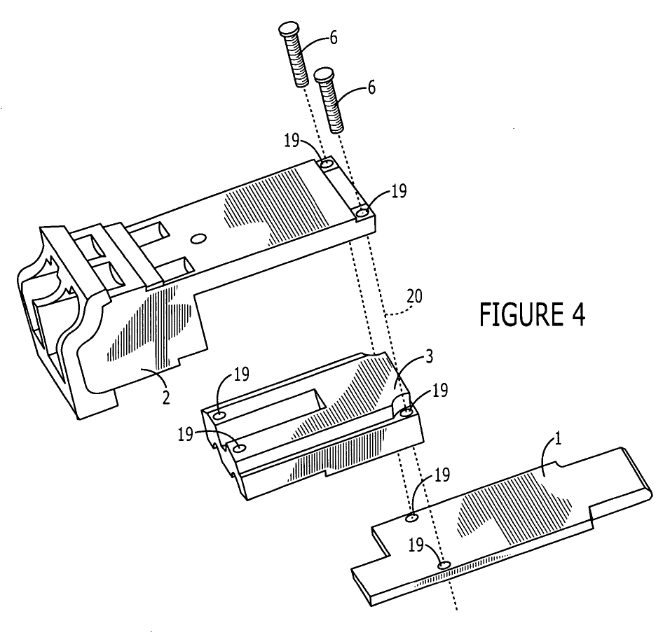

Referring to FIG. 4, the assembly of the substrate 3, connector interface 2, and circuit board 1 is shown. In a preferred embodiment, the invention comprises the steps of attaching the connector interface to the substrate and attaching the circuit board to the substrate. The order of these two steps is not critical to the invention. As shown in FIG. 3, the circuit board 1 is attached to the substrate 2 so that the board's planar surface containing the electrical contacts 13 will be parallel to the optical axis 10 of the OSA 9 once the OSA is disposed in the cavity 18 of the substrate 3. As will be discussed later, this orientation facilitates the electric coupling between the OSA and the circuit board.

To facilitate the alignment of the substrate's cavity 18 with respect to the both the connector interface 2 and the circuit board 1, at least one alignment structure 19 is incorporated into the connector interface, the substrate, and the circuit board. In a preferred embodiment, each of the components comprise the same type of structure, the structure being an orifice adapter designed to receive a pin 6. Accordingly, as shown in FIG. 4, the connector interface, substrate, and circuit board are disposed so that their orifices aline along a common axis 20. Once these three components are aligned, a pin 6 is placed through each of the orifices to fix the components together. Alternatively, two of the structures could be aligned and secured together prior to aligning the third component. It should be understood that this embodiment is only exemplary and that the invention can also be embodied in designs that incorporate alternative alignment techniques.

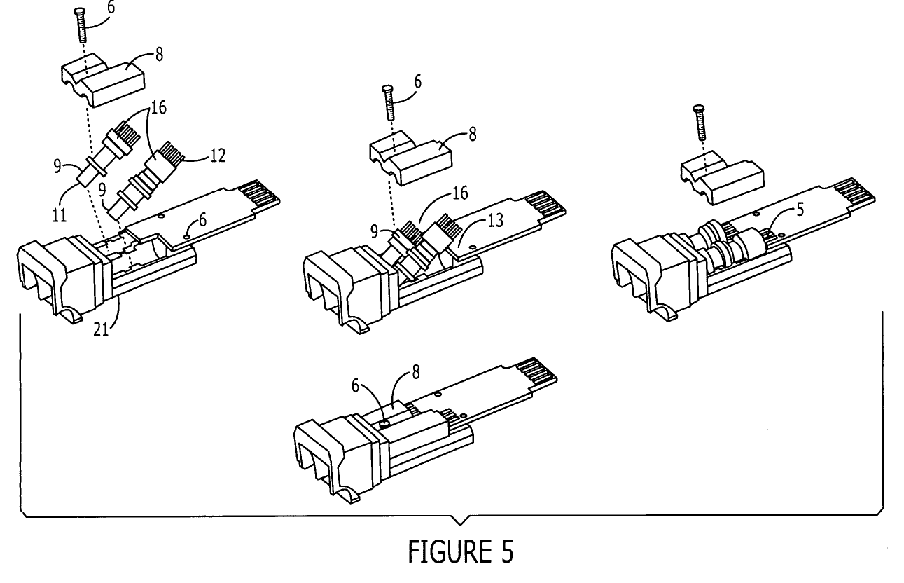

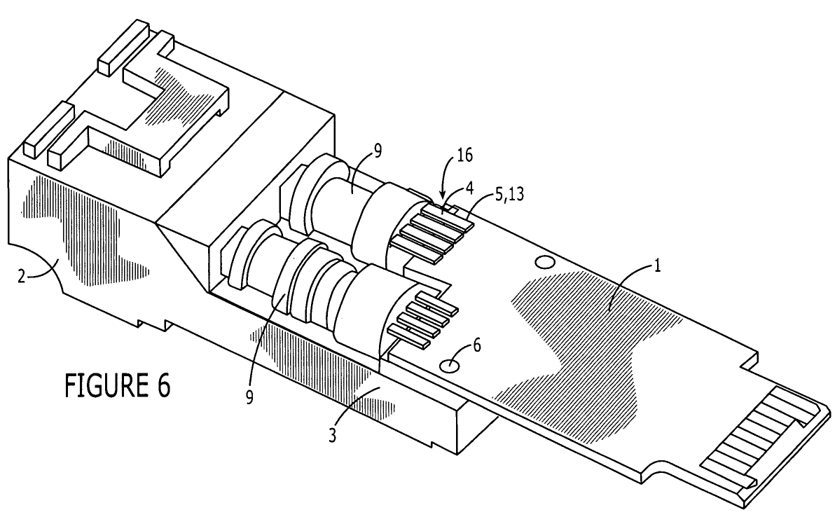

Referring to FIG. 5, the step of assembling the OSA 9 into the module is shown. In one preferred embodiment, there exists the step of inserting the OSA into a connector interface/substrate/circuit board subassembly 21. In this embodiment, the OSA is placed in the cavity of the substrate by first inserting the optical end 11 of the OSA into the connector interface portion of the subassembly and then pivoting the electrical end 12 of the OSA so that it snaps into the cavity 18. Once the OSA is inserted into the cavity, its electrical interface 16 extends over contacts 13 of the circuit board. In a more preferred embodiment, the conductors 4 of the electrical interface 16 are urged against the contacts 13 of the circuit board. The conductors may further be adjusted with respect to the contact to ease final alignment or control the level of impedance associated with the circuit. The flexible circuit does not extend between the electrical leads extending from the OSA and the contacts of the circuit board along a straight line, but instead is curved or angled 22 so that the flexible conductors are not drawn taut. This flexibility in the circuit allows some movement between the OSA and the circuit board during the assembly process thereby reducing the likelihood of damage to the electrical connections 5 and the hermetic seal 17 of the OSA during the assembly.

Once the connector interface, substrate, circuit board, and OSA have been assembled, the conductors 4 of the flexible circuit 16 are electrically connected to the contacts 13 on the circuit board 1 thereby electrically coupling the OSA with the circuit board. In one preferred embodiment, the connection 5 is made by soldering the conductors to the contacts.

In one preferred embodiment, a cover 8 is placed over the assembled OSA and secured to the substrate via a pin 6. This cover serves to protect the OSA and further secure its position with respect to the substrate.

Referring to FIGS. 8-17, an alternative module of the invention is herein described in connection with an SC, single mode, 9-pin, transceiver module for OC3, OC12 and gigabit applications. SC specifies the connector form factor. Single mode specifies that the fibers carry a single ray or mode of light as a carrier. OC3, OC12 and gigabit specify particular wavelength bands for the carrier channel. Finally, 9-pin specifies a particular electrical signal interface that includes 9 interface signal lines. However, it should be understood that this embodiment is exemplary and that the invention can be applied to receivers and transmitters. Further, the invention is not limited to the particular form factor, wavelength or mode type of the exemplary embodiment.

Referring now to the drawings and particularly FIG. 8, which is a perspective view of an opto-electronic SC transceiver in accordance with one preferred embodiment of the present invention, the transceiver 10 comprises a housing 100 formed from two mating portions 101 and 103. The housing portions preferably are non-conductive and may be fabricated from any of the polymers that are commonly used for opto-electronic module housings.

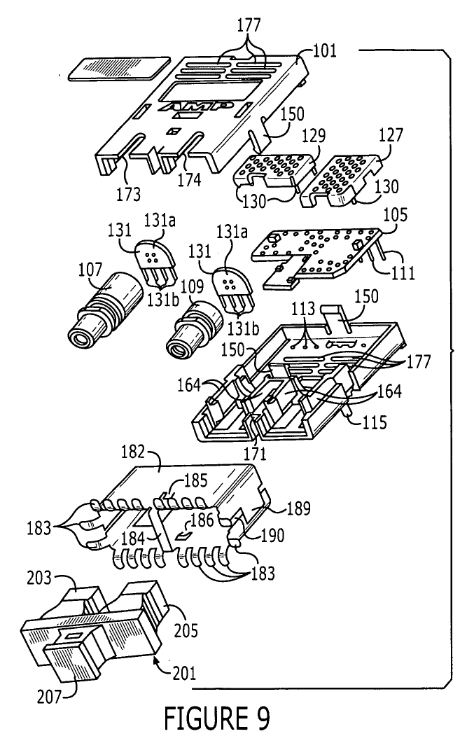

Referring now to FIG. 9, which is an exploded perspective view of the transceiver 10, enclosed within the housing are a printed circuit board 105, a transmit optical subassembly 107, and a receive optical subassembly 109. The printed circuit board 105 is populated with electronic circuitry that conditions the electrical signals as necessary. Such circuitry likely includes at least an amplifier, filters, and a digital potentiometer for adjusting the gain of the amplifier.

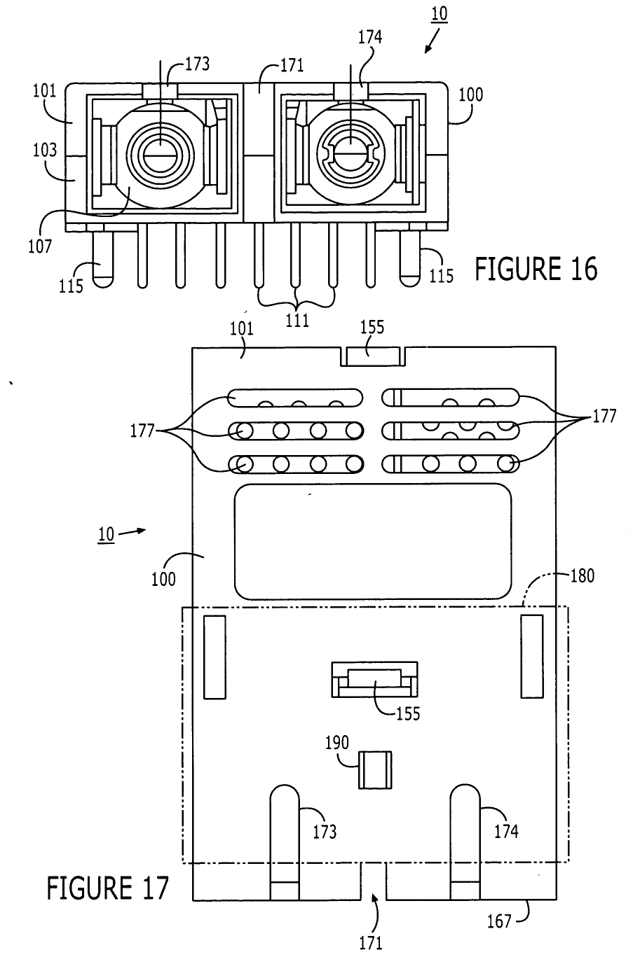

Nine pins 111 protrude from the bottom of the printed circuit board 105 and couple electrical signals between the printed circuit board 105 and external circuitry, such as a host circuit card. Particularly, the printed circuit board 105 is sized and shaped to rest flat in the back portion of the bottom half 103 of the housing with the pins 111 protruding through the holes 113 in the bottom housing half 103. See also FIG. 11, which is a perspective view of the bottom of bottom housing half 103 better showing holes 113 and FIG. 16, which is a front plan view of the assembled module showing pins 111 protruding from the bottom of the module 10. As best shown in FIG. 11, the module further includes two mounting pins 115, which are electrically isolated from the opto-electronic circuitry in the transceiver module 10. Mounting pins 115 may be formed of stainless steel. The proximal end of pins 115 press fit within holes 119 in the bottom surface of the bottom housing half 103. The proximal ends of the pins 115 may include downwardly-angled, circumferential ridges 116 that allow the pins to be inserted upwardly into the holes 119 with the circumferential ridges 116 pressing against the walls of the holes 119, 121 to form a pressure fit within the holes. However, the pins cannot be easily removed because the downwardly directed circumferential ridges 116 bite into the inner walls of the holes 119 when the pins are forced downwardly and prevent downward motion of the pin relative to the hole. Flanges 123 are integrally formed on the pins 115 near the proximal ends of the pins and have a circumference larger than the circumference of the hole and thus limit the extent to which the pins 115 can be inserted into the holes 119 on the bottom of the housing half 103.

The distal ends of the mounting pins 115 will be inserted into mating holes in the host circuit card to physically mount the module on the card. The distal ends of the mounting pins 115 may be soldered or adhered within the holes.

As is well known in the art, electromagnetic interference (EMI) is a particular problem for opto-electronic modules. Accordingly, referring again to FIG. 9, perforated metal EMI shields 127, 129 can be optionally mounted to the top surface of the printed circuit board 105 to cover the electronic circuitry on the printed circuit board and the back ends of the OSAs. Particularly, shields 127 and 129 generally take the form of five sided rectangular boxes with the bottom side open. The side walls include pins 130 that protrude downwardly and engage with mating holes on the printed circuit board 105. The pins 130 may be soldered or adhered within the holes The top surfaces 127a and 129a are perforated. In addition, there may be one or more openings 128 in the side walls to accommodate circuitry populating the PCB 105 and/or the rear portions of the optical subassemblies 107, 109.

With reference to FIGS. 9, 13 and 14, optical subassemblies 107 and 109 are mounted to the printed circuit board by flex circuits 131. Particularly, a flex circuit comprises a flexible circuit board 131a and flexible wires 131b extending therefrom. The flex circuit boards 131a are epoxied to the backs of the optical subassemblies 107, 109. The flexible wires 131b extend therefrom and curl around the edge of the PCB 105 and are soldered to the bottom side of the PCB 105.

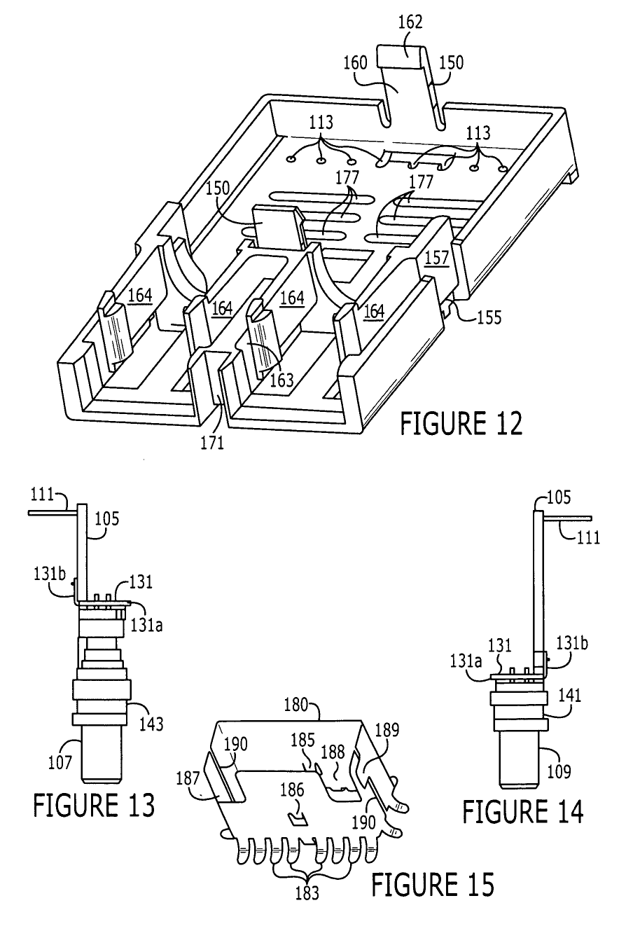

Referring now to FIG. 12, which shows the inside of the bottom housing half 103, the bottom half 103 of the housing preferably, includes formations that engage the optical subassemblies 107, 109 when the printed circuit board 105 and optical subassemblies, 107, 109 are inserted into the bottom half of the housing. For instance, extending upwardly from the inner bottom surface of bottom half 103 are two semicircular cutouts 132, 134 that engage circumferential slots 141, 143 in the optical subassemblies 107, 109 (see FIGS. 13 and 14) and generally define the position and orientation of the optical subassemblies.

As best seen in FIGS. 8-11, transverse flow-through slots 177 are formed in the rear portions of both halves 101, 103 of the housing 100. As is well known in the art, it is common to immerse an opto-electronic module in an aqueous liquid bath during or at the end of fabrication in order to clean the module. The flow-through slots 177 allow better infiltration of the aqueous solution into the housing and thus allow better cleansing of the OSAs and PCB.

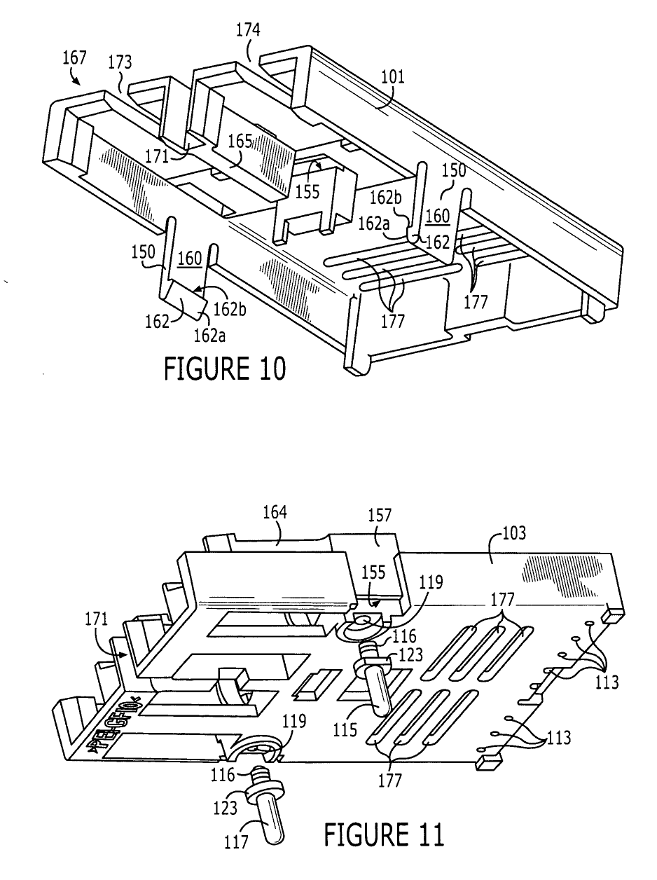

With reference to FIGS. 10 and 12, the top and bottom halves 101, 103 are shaped to mate with each other and enclose the internal components. They couple to each other via latches 150 on one half and mating shoulders 155 on the other half. Preferably, housing halves 101, 103 each include two latches and two shoulders. Each latch 150 comprises a resilient bar 160 that is attached to or integral with the corresponding housing half at its proximal end and includes a dog 162 at its distal end. The dogs 162 comprise an angled outer surface 162a and an inner surface 162b that is normal to the length of the bar portion 160. When the two halves 101, 103 are pushed together, the angled outer surfaces 162a of the dogs 162 engage vertical surfaces 156 adjacent the corresponding shoulders 155 on the other housing half. Because the outer surface 162a of dogs 162 are angled as shown, when the outer surface 162a of the dog 162 encounters the surface 156 adjacent the corresponding shoulder 155 of the other half, it forces the resilient bar 160 to bend outwardly. When the two halves 101, 103 reach the final mating position, the dogs 162 clear the shoulders 155, thus, allowing the resilient bars 160 to snap back to their neutral position, thus engaging the inner surface 162b of the dog against the mating shoulder 155 on the other half. The two halves 101, 103 are thus locked together by the latches 150 and shoulders 155.

Because the inner surface 162b of the dogs 162 are parallel to the shoulder, the two halves 101, 103 cannot be separated from each other. However, by simultaneously biasing the bars 160 of all four latches 150 outwardly, the dogs 162 can be disengaged from the corresponding shoulders 155 and the two halves separated. Accordingly, the two halves 101, 103 provide a secure housing that encloses and protects the electronic and optical components of the module, yet the housing can be opened at any stage during manufacturing or afterwards to allow access to the internal components.

This is a substantial advantage over prior art housings in which the optical and electronic circuitry were permanently encapsulated such that access could not be obtained to the optical and electronic circuitry without destruction of the module and/or circuitry itself.

With reference to FIG. 12, in the front end or nose of the bottom half 103 of the housing, four more latches 164 are designed to engage mating shoulders of an SC duplex plug (not shown), as is well known in the art. Integral with the bottom housing half 103 is a wall 163 between the two optical subassemblies 107, 109. Referring to FIG. 10, a mating wall 165 is found in the top housing half 101. When the two halves 101, 103 are brought together, walls 163 and 165 meet and form a full height internal wall that separates the front ends of the optical subassemblies 107 and 109 from each other. The top and bottom housing halves 101, 103 meet to form a front opening 167 of the module (see FIG. 1, for instance). The front of the housing has a recessed wall 171 between the two optical subassemblies. Otherwise the front of the module is open.

As best shown in FIGS. 8, 9 and 10, the top half 101 includes two slots 173 and 174 that are open to the front end 167 of the housing. These slots 173 and 174 are generally aligned with the OSAs in the plan views of FIGS. 9 and 10. Slots 173 and 174 accept the key or polarizing member that is found on one side surface of a SC plug. The key on an SC plug and the mating channel or slot on an SC connector is included as part of the SC standard in order to assure that an SC plug can be inserted into an SC connector in only one orientation. The key provides an asymmetric feature in the otherwise symmetric SC form factor.

An external EMI gasket 180 can be mounted on the front end or nose piece of the housing to provide enhanced EMI shielding. With reference to FIG. 15, the gasket 180 includes a main body portion 182 sized and shaped to circumscribe the front end of the housing. The gasket 180 is conductive and is preferably formed of a thin, flexible sheet metal. The bottom surface of the gasket has its rear comers cut out to accommodate the mounting pins 115 and 117. The front end of the gasket includes a plurality of flexible fingers 183 extending generally radially outwardly from the gasket. The front end also includes a support member 184 running vertically down the center of the front of the gasket (see FIG. 2), but is otherwise open at the front and back. The gasket 180 slides onto the front end of the housing until support member 184 meets wall 171 of the housing (best shown in FIGS. 3, 4, and 5), thus defining the proper position of the gasket. FIG. 10 shows the position of the gasket 180 in outline form when mounted on the front end of the module 100.

The gasket further includes two cutout tabs 187 and 188 in the top and bottom sides, respectively. The tabs are resilient and extend from the body of the gasket toward the front opening of the gasket 180 and slightly inwardly. The tabs, preferably, are formed integrally with the gasket by cutting out the surrounding metal. Accordingly, when the gasket is slid onto the nose piece of the module, the tabs 185 and 186 bend outwardly as they contact the top and bottom surfaces of the housing until the gasket is fully inserted, at which point tabs 185 and 186 meet apertures 190, 191 on the top and bottom surfaces, respectively, of the housing (see FIGS. 8 and 11). At that point, they resiliently snap into the apertures and thus prevent the gasket from being slid forward off of the housing. However, if necessary, the gasket can be removed, by bending both tabs 185 and 186 outwardly. This may be accomplished by slipping thin sheets between the gasket 180 and the housing from the rear of the housing so as to bend the tabs outwardly and release them from engagement with the edges of the apertures 190, 191.

In one preferred embodiment of the invention, the gasket is stamped from a single sheet. The sheet is then folded into the shape of the gasket. Plates 189 are then spot welded to the two side surfaces of the gasket. A gap 190 may remain at the sides. Finally, the fingers 183 are bent outwardly.

The fingers 183 of the gasket, are designed to contact the front surface of the face plate or bulk head when the module 100 is mounted in a host device in which the nose extends through a face plate or bulk head. Accordingly, the conductive gasket surrounding the nose piece makes electrical and physical contact with the face plate of the chassis or host device, which, presumably is electrically coupled to chassis ground and thus helps enhance EMI shielding of the module. Since the fingers are resilient, they provide some leeway in the positioning of the module relative to the face plate in the direction of the optical axis of the module. The fingers can flex to accommodate slightly different depths of the module behind the faceplate with the fingers still contacting the front of the faceplate.

Referring again to FIG. 8, a rubber boot 201 may be provided with the module. The boot 201 has a handle 207 and is designed to be inserted into the front end 167 of the module so that the two plugs 203, 205 surround the optical subassemblies 107, 109, respectively. The plugs 203, 205 define cylindrical openings (not seen in the Figures) that slip over and surround the OSAs to protect them prior to deployment of the module. The plugs protect the OSAs in two respects. First, they assist in holding the OSAs steady prior to being coupled to an optical fiber. Recall that the OSAs are coupled to the PCB by flex circuit and thus can move about within the module and possibly damage the wire connectors of the flex circuit. Secondly, the plugs cover the front openings of the OSAs during the aqueous bath stage of fabrication and thus help prevent liquid from entering internally to the OSAs. The boot 201, of course, is removed prior to deployment of the module so that optical fibers can be coupled to the OSAs.

Having thus described a few particular embodiments of the invention, various alterations, modifications, and improvements will readily occur to those skilled in the art. Such altercations, modifications, and improvements as are made obvious by this disclose are intended to be part of this description though not expressly stated herein, and are intended to be within the spirit and scope of the invention. Accordingly, the foregoing description is be way of example only and is not limiting. The invention is limited only as defined by the following claims and equivalents thereto.

1. A method for assembling an opto-electric module comprising at least one OSA having an optical axis, an optical end, an electrical end, and an electrical interface at said electrical end, a circuit board having electrical contacts, and a connector interface cooperating with said OSA such that an optical connector received in said connector interface is optically coupled to said OSA, said method comprising:
providing an assembly comprising said connector interface and a substrate having a cavity for receiving said OSA, said cavity being aligned with said connector interface such that, when the OSA is disposed in the cavity, the OSA is positioned to optically couple with a mating connector of an optical component connected to said connector interface;
affixing said circuit board to said substrate in a particular position relative to said cavity such that, when said OSA is disposed in said cavity, said electrical interface is positioned to electrically couple with contacts on said circuit board;
placing said OSA in said cavity; and
electrically connecting said electrical interface to said contacts after said OSA is disposed in said cavity and said circuit board is fixed to said substrate.

2. The method of claim 1, wherein said cavity is dimensioned to receive said OSA snugly so that the position of said OSA is defined within said module.

3. The method of claim 2, wherein said substrate is resilient and urges against said OSA when said OSA is placed therein.

4. The method of claim 3, wherein placing said OSA in said cavity comprises snapping said OSA into said cavity.

5. The method of claim 1, wherein said substrate comprises at least a second cavity.

6. The method of claim 1, wherein said substrate comprises a first structure to align said connector interface to said cavity.

7. The method of claim 1, wherein said substrate comprises a second structure to align said circuit board relative to said cavity.

8. The method of claim 7, wherein said second structure is an orifice adapter to receive a pin and said circuit board comprises an orifice to receive a pin, and wherein affixing said circuit board to said substrate comprises sequentially inserting a pin through an orifice of said circuit board and an orifice through said substrate.

9. The method of claim 1, wherein said OSA is placed in said cavity by first inserting said optical end thereof into said connector interface and then placing said electrical end into said cavity such that said electrical interface is urged against said circuit board.

10. The method of claim 1, wherein said OSA is one of either a receiving OSA or a transmitting OSA.

11. The method of claim 5, further comprising a second OSA wherein said second OSA is either a receiving OSA or a transmitting OSA.

12. The method of claim 1, wherein said electrical interface comprises electrical leads extending from said OSA essentially parallel to the optical axis of said OSA and a flexible circuit of electrical conductors extending orthogonally from said electrical leads.

13. The method of claim 12, wherein said circuit board has a top and bottom orientation when mounted on said substrate, said contacts being disposed on said top of said circuit board, and wherein said OSA is placed in said cavity such that said electrical conductors overlay said contacts.

14. The method of claim 13, wherein said conductors are resilient and are biased into said circuit board when said OSA is disposed in said cavity.

15. The method of claim 14, wherein said flexible circuit does not extend between said electrical leads and said contacts in a straight line.

16. The method of claim 15, wherein said circuit board is planar and parallel to said optical axis.

17. The method of claim 16, wherein said flexible circuit extends orthogonally from said electrical leads and bends around toward said circuit board.

18. The method of claim 13, where the position of said electrical conductors is adjusted with respect to said contacts after said OSA is placed in said cavity.

19. The method of claim 18, wherein the amount of overlap between said contacts and said electrical conductors is adjusted to control impedance.

20. The method of claim 1, further comprising attaching a cover to said substrate to contain and hold secure said OSA.

21. An opto-electric module comprising:
an OSA having an optical axis, and optical end, an electrical end;
a planar circuit board having top and bottom surfaces and one or more electrical contacts on at least one of said surfaces of said circuit board;
a connector interface for receiving a mating connector;
a substrate connected to said connector interface, said OSA and said circuit board, said substrate holding said circuit board parallel to said optical axis of said OSA; and
an electrical interface between said electrical end of said OSA and said electrical contacts of said circuit board, said electrical interface comprising a flexible conductor extending orthogonally from said optical axis of said OSA and bending around to overlay said electrical contacts on said circuit board.

22. The module of claim 22, wherein said substrate is attached to said optical connector and said circuit board by pins.

23. The module of claim 22, wherein said substrate and said optical connector are integrally molded.

24. The module of claim 22, wherein the OSA is either a receiving OSA or a transmitting OSA.

25. The module of claim 22, further comprising a second OSA, wherein said OSA is a receiving OSA and said second OSA is a transmitting OSA.

26. The module of claim 25, wherein said electrical interface comprises said electrical leads extending from said OSA essentially parallel to the optical axis of said OSA and said flexible circuit extending orthogonally from said electrical leads.

27. The module of claim 26, wherein said flexible circuit comprises electrical conductors which are resilient and are biased into said circuit board.

28. The module of claim 26, wherein said electrical contacts are located on said top surface of said circuit, said flexible conductor overlaying said electrical contacts on said top surface of said circuit board.

29. The module of claim 22, further comprising a cover attached to said substrate so that said OSA is covered.
